(19) United States
(12) Patent Application Publication
(10) Pub. No.: US 2020/0320549 A1
(43) Pub. Date: Oct. 8, 2020

(54) METHOD AND SYSTEM FOR INTEGRATED CONTEXTUAL PERFORMANCE ANALYSIS

(71) Applicant: MediaAgility Inc., Princeton, NJ (US)

(72) Inventor: Arpit Agrawal, Princeton, NJ (US)

(73) Assignee: MediaAgility Inc., Princeton, NJ (US)

(21) Appl. No.: 16/730,968

(22) Filed: Dec. 30, 2019

Related U.S. Application Data
(60) Provisional application No. 62/829,303, filed on Apr. 4, 2019.

(51) Int. Cl. G06Q 30/02; G06N 3/08

(52) U.S. Cl. CPC G06Q 30/0201; G06N 3/08

(57) ABSTRACT

Disclosed are systems (100) and (300) and a method (200) for integrated contextual performance analysis. As per an aspect of the disclosure, an integrated approach of audience analysis, performance feed and ambiance analysis, is described for evolving the performance analysis. One more aspect of the disclosure describes the audience analysis comprising simultaneous image, video and audio analysis of the audience feed. Yet another aspect of the disclosure elaborates the use of performance feed in conjunction with audience analysis. One more aspect of the disclosure describes integrating the ambiance analysis to the audience analysis and the performance feed.

### RELATED APPLICATIONS

This Application claims priority benefit of U.S. Patent Application No. 62/829,303, filed Apr. 4, 2019, which contents are incorporated entirely by reference herein for all purposes.

### FIELD

The present invention relates to the field of analysis of performance. More specifically, the invention relates to the field of analysis of performance using intelligent, integrated and contextual data associated with the performance using multiple types of inputs.

### BACKGROUND ART

For this disclosure, the word “performance” is related to an audio-visual event. In an exemplary manner, the event or performance comprises a skit, a play, a game, a lecture, a meeting, a show, an interview, a movie, live entertainment, a political rally, a talent show, a speech, a sports event or a campaign. There is no systematic method of measuring the integrated impact of a performance (live or recorded) on the audience. The audience shows changes in emotions throughout the performance. For measurement of performance analysis, the traditional method is to request for feedback explicitly. That method is not traditionally real time and is likely to contain bias.

Several publications, patents and patent applications related to the topic are found in the prior art. The U.S. Pat. No. 9,516,380B2 “Automatic transition of content based on facial recognition” describes automatic transition of content based on facial recognition. Patent U.S. Pat. No. 7,999,857 describes voice, lip-reading, face and emotion stress analysis and also describes fuzzy logic intelligent camera system. “https://madsystems.com” describes a face-recognition based media delivery system. US 20020072952 elaborates visual and audible consumer reaction collection. Further, U.S. Pat. No. 8,290,604 explains audience condition-based media selection.

In view of the prior art, there is a need of an integrated synthesis of the audience, the performance and the ambiance feed. There is no reference compared to the conventional feedback-based performance analysis and the prior art, to an implicit method that is objective and real-time and hence more likely to capture the true emotional impact of that performance on each individual user and aggregate it.

### SUMMARY OF THE INVENTION

A method and systems are described for integrated contextual performance analysis.

One aspect of the disclosure describes an integrated approach of audience analysis, performance feed and ambiance analysis for evolving the performance analysis.

One more aspect of the disclosure describes the audience analysis comprising simultaneous image, video and audio analysis of the audience feed.

Yet another aspect of the disclosure elaborates the use of performance feed in conjunction with audience analysis.

One more aspect of the disclosure describes integrating the ambiance analysis to the audience analysis and the performance feed.

### BRIEF DESCRIPTION OF THE DRAWINGS

For a more complete understanding of the present invention and the advantages thereof, reference is now made to the following descriptions taken in connection with the accompanying drawings in which:

FIG. 1 explains an overview of a system (100) for integrated contextual performance analysis;

FIG. 2 depicts a flowchart for a method (200) for integrated contextual performance analysis, in which one or more steps of the logic flow can be mapped to various blocks of system (100) of FIG. 1; and

FIG. 3 depicts a system (300) with a memory (301) and a processor configured for integrated contextual performance analysis, wherein the memory and the processor are functionally coupled to each other

### DETAILED DESCRIPTION OF THE EMBODIMENTS

A method and systems are described for integrated contextual performance analysis.

The performance that is to be analyzed may be, in an exemplary manner, a skit, a play, a game, a lecture, a meeting, a show or a campaign.

One aspect of the disclosure describes an integrated approach of audience analysis, performance feed and ambiance analysis for evolving the performance analysis. One more aspect of the disclosure describes the audience analysis comprising simultaneous image, video and audio analysis of the audience feed. Yet another aspect of the disclosure elaborates the use of performance feed in conjunction with audience analysis. One more aspect of the disclosure describes integrating the ambiance analysis to the audience analysis and the performance feed.

The system could also be a computer readable medium, functionally coupled to a memory, where the computer readable medium is configured to implement the exemplary steps of the method. The system can be implemented as a stand-alone solution, as a Software-as-a-Service (SaaS) model or a cloud solution or any combination thereof.

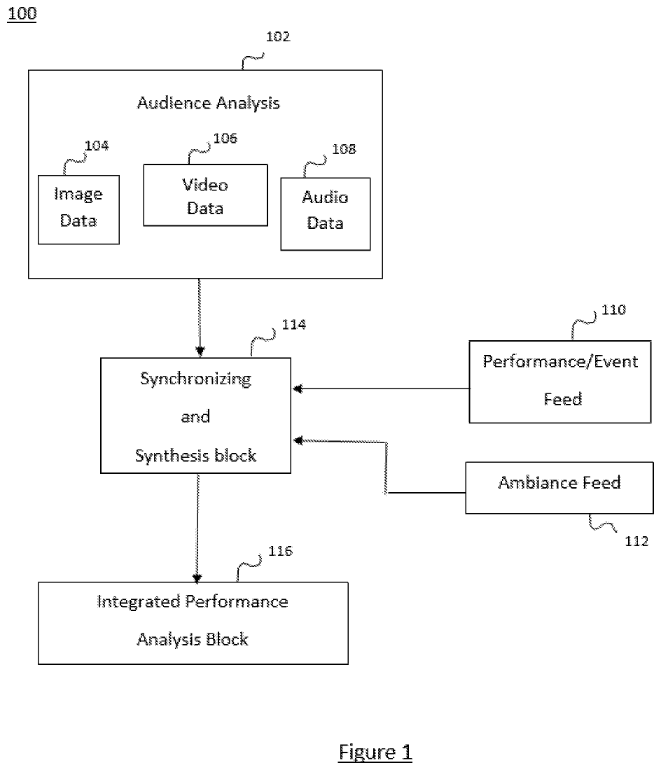

Now referring to FIG. 1, various elements of the system (100) are described. FIG. 1 explains an overview of the system (100) for integrated contextual performance analysis. Three elements are described which are feeds to the analysis. Element (102) describes the audience analysis associated with the performance, element (110) describes performance or event feed associated with the performance and element (112) describes ambiance feed associated with the performance. Within element (102), there are three sub-elements: element (104) describes image data associated with the performance, element (106) describes video data associated with the performance and element (108) describes audio data associated with the performance.

In an exemplary manner, element (104) which is image data, is facial detection with facial emotion or expression classification for the audience showing if they are interested, if their posture is that of interest or not etc. In an exemplary manner, element (104) would classify and quantify human emotion using Computer Vision and Deep Learning as applied to facial images for different frames of the video. The same solution may be applied to human figures to identify “body language” from different frames of the video.

In an exemplary manner, element (106) is video data, where the video data may include a plurality of actions done by the audience, audience indicating wiping off tears, clapping, yawning or jumping, if they are fidgeting etc. In an exemplary manner element (106) may take series of frames instead of a single frame when performing the action/video analytics. Specific actions, for example clapping or cheering, as identified by Deep Learning, in different set of frames would be indicative of different emotional patterns. Standing ovation is also an action that is considered in audience analysis for approval, respect or anticipation.

Element (108), in an exemplary manner, is audio data from the audience indicative of if the audience is cheering, phrases indicating happiness, applause, high pitch or shrill noise, any disapproval phrases or words or audio signals and sobbing etc.

Element (110) describes performance or event feed and this could be live or video recorded. The Element (110) also includes associated intended and expected emotion of the audience corresponding to the event feed. Element (112) describes ambiance feed and in an exemplary manner may include how many people are attending, how they are sitting in the auditorium or arena or the hall where the performance or event is taking place, whether they are closer towards the stage or at the back or they are randomly distributed. Element (112) also analyzes the demographic distribution based on the audience age/gender etc. Ambiance analysis also comprises temporal changes in audience: e.g. if at the beginning of the event, lot of audience was there and after certain aspects of the event or towards the end, the audience left, indicating disapproval or disinterest or both. Ambiance analysis also comprises, standing ovation if received, and by how many etc.

Element (114) is Synchronizing and Synthesis Block that synchronizes the three feeds (102), (110) and (112), to synthesize all the elements and sub-elements to evolve an integrated contextual performance analysis. In an exemplary manner, the granular demographic information from the audience analysis (102) such as gender, age-group, ethnicity etc. of a sub-section of the audience can be synchronized with the corresponding response from the ambiance feed (112) to be able to obtain valuable insights about the performance.

Element (116) is Integrated Performance Analysis Block, which is used for storing and visualizing the integrated contextual performance analysis.

Scores for different kind of emotions (fear, joy, sorry, anger etc.) would be received from each independent feed from elements (104), (106) and (108) and then consolidated and synchronized to evolve a consolidated score for each emotion within element (102). Consolidation might be one of the different methods including but not limited to: sum, average, weighted-sum etc.

In element (114), the individual emotion scores and the consolidated emotion score obtained in element (102), would be mapped and synchronized with the performance timeline obtained from element (110) as well as ambiance analysis obtained from element (112), to evolve the variation in impact of the performance (by measuring human emotions) at different times throughout the performance. The correlation between the three feeds from elements (102), element (110), and element (112) would measure the performance analysis.

The element (114) of the system (100) in accordance with the present invention is deployable across a plurality of computing platforms using heterogeneous server and storage farms. The system (100) is deployable using multiple hardware and integration options, such as, for example, solutions mounted on mobile hardware devices, third-party platforms and system solutions etc. The element (114) could also be a computer readable medium, functionally coupled to a memory, where the computer readable medium is configured to implement various steps and calculations for synchronization and synthesis. The element (114) can be implemented as a stand-alone solution, as manual, as a Software-as-a-Service (SaaS) model or a cloud solution or any combination thereof.

The element (114) of system (100) may use analytics, statistics, artificial intelligence (AI) tools, machine learning tools, deep learning tools or any combination thereof.

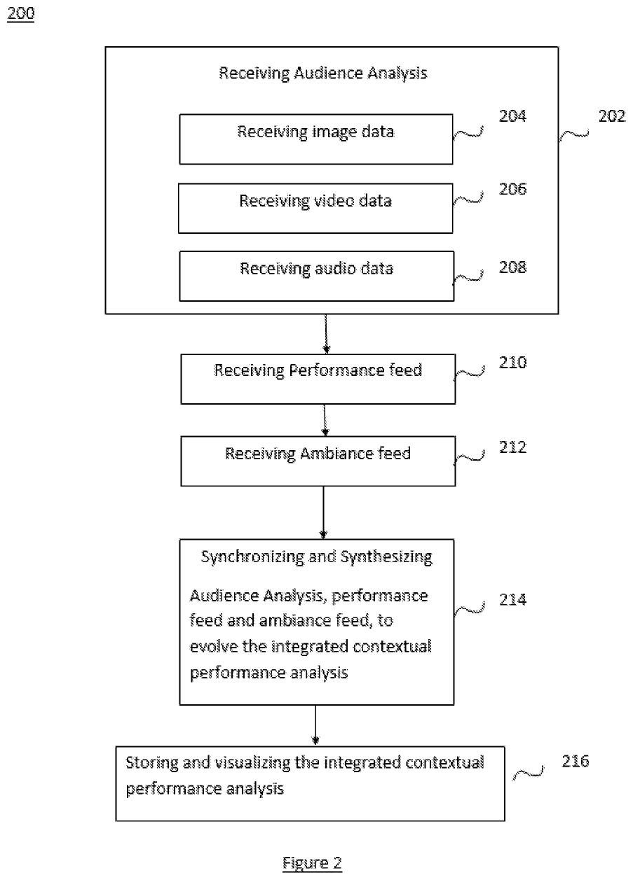

FIG. 2 depicts a flowchart for a method (200) for integrated contextual performance analysis, in which one or more steps of the logic flow can be mapped to various blocks of system (100) of FIG. 1. Thus, the method (200) is consistent with the system (100) described in FIG. 1, and is explained in conjunction with components of the system (100).

Step (202) describes receiving an audience analysis (102) associated with the performance. Within the step (202) are three sub-steps which are assigned for specific three aspects. Step (204) describes receiving image data (104) associated with the performance, which further comprises facial detection with facial emotion or expression classification and posture recognition. Step (206) describes receiving video data (106) of the audience associated with the performance, which comprises a plurality of actions, and step (208) describes receiving audio data (108) of the audience associated with the performance, which comprises a plurality of words and noises and corresponding pitch.

Step (210) depicts receiving performance feed (110) and the performance feed (110) is selected from a set comprising live performance, recorded performance and a combination thereof and receiving associated intended and expected emotion of the audience corresponding to the performance feed.

Step (212) describes receiving ambiance feed (112) comprises seating configuration of audience of the performance, demographic distribution of the audience of the performance, both in a temporal manner.

Step (214) depicts synchronizing and analyzing inputs from the audience analysis (102), the performance feed (110) and the ambiance feed (112) to evolve the integrated contextual performance analysis, wherein the synchronizing and analyzing takes place in a synchronizing and synthesis block (114). Further, the synchronizing and synthesis block (114) uses analytics, statistics, AI tools, machine learning tools, deep learning tools or any combination thereof, for evolving the integrated contextual performance analysis.

Step (216) describes storing and visualizing the integrated contextual performance analysis in an integrated performance analysis block (116), wherein the integrated contextual performance analysis is evolved by the synchronizing and synthesis block (114).

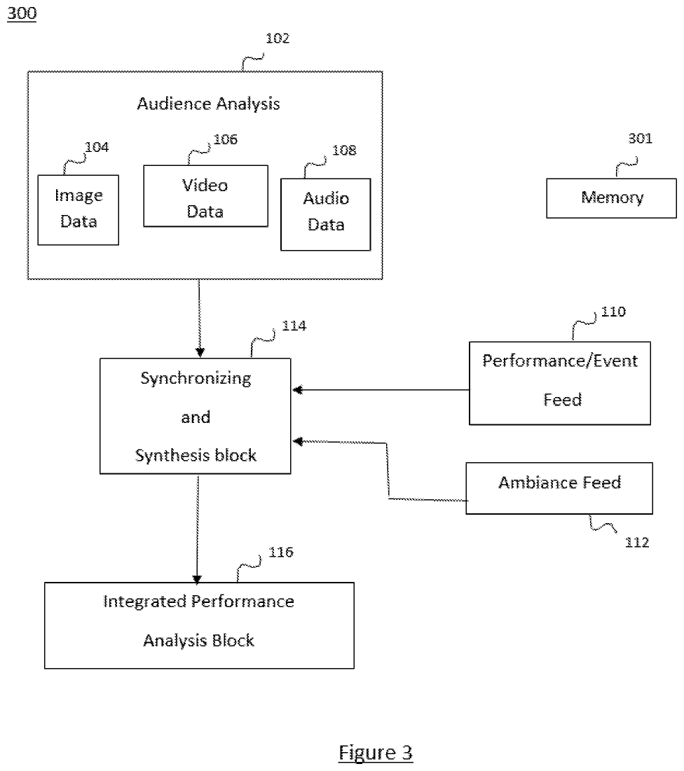

FIG. 3 depicts a system (300) with a memory (301) and a processor configured for integrated contextual performance analysis, wherein the memory (301) and the processor are functionally coupled to each other. The processor of the system (300) is configured to carry out the steps (202) to step (216) of FIG. 2.

Now referring to FIG. 3, various elements of the system (300) are described. FIG. 3 explains an overview of the system (300) for integrated contextual performance analysis. Three elements are described which are feeds to the analysis. Element (102) describes the audience analysis associated with the performance, element (110) describes performance or event feed associated with the performance and element (112) describes ambiance feed associated with the performance. Within element (102), there are three sub-elements: element (104) describes image data associated with the performance, element (106) describes video data associated with the performance and element (108) describes audio data associated with the performance.

In an exemplary manner, element (104) which is image data, is facial detection with facial emotion or expression classification for the audience showing if they are interested, if their posture is that of interest or not etc. In an exemplary manner, element (104) would classify and quantify human emotion using computer vision and deep learning as applied to facial images for different frames of the video. The same solution may be applied to human figures to identify “body language” from different frames of the video.

In an exemplary manner, element (106) is video data, where the video data may include a plurality of actions done by the audience, audience indicating wiping off tears, clapping, yawning or jumping, if they are fidgeting etc. In an exemplary manner element (106) may take series of frames instead of a single frame when performing the action/video analytics. Specific actions, for example clapping or cheering, as identified by deep learning, in different set of frames would be indicative of different emotional patterns. Standing ovation is also an action that is considered in audience analysis for approval, respect or anticipation.

Element (108), in an exemplary manner, is audio data from the audience indicative of if the audience is cheering, phrases indicating happiness, applause, high pitch or shrill noise, any disapproval phrases or words or audio signals and sobbing etc.

Element (110) describes performance or event feed and this could be live or video recorded. The Element (110) also included associated intended and expected emotion of the audience corresponding to the event feed. Element (112) describes ambiance feed and in an exemplary manner may include how many people are attending, how they are sitting in the auditorium or arena or the hall where the performance or event is taking place, whether they are closer towards the stage or at the back or they are randomly distributed. Element (112) can also analyze the demographic distribution based on the audience age/gender etc. Ambiance analysis also comprises temporal changes in audience: e.g. if at the beginning of the event, lot of audience was there and after certain aspects of the event or towards the end, the audience left, indicating disapproval or disinterest or both. Ambiance analysis also comprises, standing ovation if received, and by how many etc.

Element (114) is Synchronizing and Synthesis Block that synchronizes the three feeds (102), (110) and (112), to synthesize all the elements and sub-elements to evolve an integrated contextual performance analysis.

Element (116) is Integrated Performance Analysis Block, which is used for storing and visualizing the integrated contextual performance analysis.

Scores for different kind of emotions (fear, joy, sorry, anger etc.) would be received from each independent feed from elements (104), (106) and (108) and then consolidated and synchronized to evolve a consolidated score for each emotion within element (102). Consolidation might be one of the different methods including but not limited to: sum, average, weighted-sum etc.

In element (114), the individual emotion scores and the consolidated emotion score obtained in element (102), would be mapped and synchronized with the performance timeline obtained from element (110) as well as ambiance analysis obtained from element (112), to evolve the variation in impact of the performance (by measuring human emotions) at different times throughout the performance. The Correlation between the three feeds from elements (102), element (110), and element (112) would measure the performance analysis.

The element (114) of the system (300) in accordance with the present invention is deployable across a plurality of computing platforms using heterogeneous server and storage farms. The system (300) is deployable using multiple hardware and integration options, such as, for example, solutions mounted on mobile hardware devices, third-party platforms and system solutions etc. The element (114) could also be a computer readable medium, functionally coupled to the memory (301), where the computer readable medium is configured to implement various steps and calculations for synchronization and synthesis. The element (114) can be implemented as a stand-alone solution, as manual, as a Software-as-a-Service (SaaS) model or a cloud solution or any combination thereof.

The element (114) of system (300) may use analytics, statistics, AI tools, machine learning tools, deep learning tools or any combination thereof.

There are several advantages of the integrated contextual performance analysis. One of the advantages is the integrated synthesis of the audience, the performance and the ambiance feed. Another advantage of the invention is that compared to the conventional feedback-based performance analysis, the proposed method is implicit, objective and real-time and hence more likely to captures the true emotional impact of that performance on each individual user and aggregate it.

Yet another advantage is that based on the synthesis, refining and better planning for subsequent events/performances can be done to improve outcomes. One more advantage of the disclosure is an objective assessment and comparison of various performances and performers, which helps in selection of the right mix of performers for subsequent performances. Yet another advantage of the disclosure if that the analysis can give cost-benefit analysis and safety aspects of a part of the performance. E.g. in a circus or acrobatic performance, if a double flip is garnering same impact than a triple flip, a double flip might be safer for some younger or less experienced performers without compromising the outcomes.

1. A system (100) for integrated contextual performance analysis, comprising:
an audience analysis (102) associated with the performance;
a performance feed (110) associated with the performance;
an ambience feed (112) associated with the performance; and
a synchronizing and synthesis block (114), wherein inputs from the audience analysis (102), the performance feed (110) and the ambiance feed (112) are synchronously analysed, to evolve the integrated contextual performance analysis.

2. The system (100) of claim 1, wherein the audience analysis (102) comprises:
image data (104) associated with the performance;
video data (106) associated with the performance; and
audio data (108) associated with the performance.

3. The system (100) of claim 2, wherein:
image data (104) comprises facial detection with facial emotion classification and posture recognition;
video data (106) comprises a plurality of actions; and
audio data (108) comprises a plurality of words and noises and corresponding pitch.

4. The system (100) of claim 1, wherein the performance feed (110) is selected from a set comprising live performance, recorded performance, and a combination thereof.

5. The system (100) of claim 1, wherein the ambiance feed (112) comprises seating configuration of audience of the performance, demographic distribution of the audience of the performance, both in a temporal manner.

6. The system (100) of claim 1, wherein the synchronizing and synthesis block (114) uses analytics, statistics, artificial intelligence (AI) tools, machine learning tools, deep learning tools or any combination thereof, for evolving the integrated contextual performance analysis.

7. The system (100) of claim 1 further comprising an integrated performance analysis block (116) for storing and visualizing the integrated contextual performance analysis evolved by the synchronizing and synthesis block (114).

8. A method (200) for integrated contextual performance analysis, comprising:
receiving an audience analysis (102) associated with the performance;
receiving a performance feed (110) associated with the performance;
receiving an ambience feed (112) associated with the performance; and
synchronizing and analysing inputs from the audience analysis (102), the performance feed (110) and the ambiance feed (112) to evolve the integrated contextual performance analysis, wherein the synchronizing and analysing takes place in a synchronizing and synthesis block (114).

9. The method (200) of claim 8, wherein the audience analysis (102) comprises:
image data (104) associated with the performance;
video data (106) associated with the performance; and
audio data (108) associated with the performance.

10. The method (200) of claim 9, wherein:
the image data (104) comprises facial detection with facial emotion classification and posture recognition;
the video data (106) comprises a plurality of actions; and
the audio data (108) comprises a plurality of words and noises and corresponding pitch.

11. The method (200) of claim 8, wherein the performance feed (110) is selected from a set comprising live performance, recorded performance, and a combination thereof.

12. The method (200) of claim 8, wherein the ambiance feed (112) comprises seating configuration of audience of the performance, demographic distribution of the audience of the performance, both in a temporal manner.

13. The method (200) of claim 8, wherein the synchronizing and synthesis block (114) uses analytics, statistics, artificial intelligence (AI) tools, machine learning tools, deep learning tools or any combination thereof, for evolving the integrated contextual performance analysis.

14. The method (200) of claim 8, further comprising storing and visualizing the integrated contextual performance analysis in an integrated performance analysis block (116), wherein the integrated contextual performance analysis is evolved by the synchronizing and synthesis block (114).

15. A system (300) for integrated contextual performance analysis, the system (300) comprising at least a processor and a memory (301), wherein the memory (301) and the processor are functionally coupled to each other, and the system (300) further comprising:
an audience analysis (102) associated with the performance;
a performance feed (110) associated with the performance;
an ambience feed (112) associated with the performance; and
a synchronizing and synthesis block (114), wherein inputs from the audience analysis (102), the performance feed (110) and the ambiance feed (112) are synchronously analysed, to evolve the integrated contextual performance analysis.

16. The system (300) of claim 15, wherein the audience analysis (102) comprises:
image data (104) associated with the performance, wherein the image data (104) comprises facial detection with facial emotion classification and posture recognition;
video data (106) associated with the performance, wherein the video data (106) comprises a plurality of actions; and
audio data (108) associated with the performance, wherein the audio data (108) comprises a plurality of words and noises and corresponding pitch.

17. The system (300) of claim 15, wherein the performance feed (110) is selected from a set comprising live performance, recorded performance, and a combination thereof.

18. The system (300) of claim 15, wherein the ambiance feed (112) comprises seating configuration of audience of the performance, demographic distribution of the audience of the performance, both in a temporal manner.

19. The system (300) of claim 15, wherein the synchronizing and synthesis block (114) uses analytics, statistics, artificial intelligence (AI) tools, machine learning tools, deep learning tools or any combination thereof, for evolving the integrated contextual performance analysis.

20. The system (300) of claim 15, further comprising an integrated performance analysis block (116) for storing and visualizing the integrated contextual performance analysis evolved by the synchronizing and synthesis block (114).
